(19) United States
(12) Patent Application Publication
(10) Pub. No.: US 2014/0334553 A1
(43) Pub. Date: Nov. 13, 2014

(54) METHODS AND APPARATUSES INCLUDING A STATISTICAL MULTIPLEXER WITH BITRATE SMOOTHING

(71) Applicant: MAGNUM SEMICONDUCTOR, INC., Milpitas, CA (US)

(72) Inventors: Pavel Novotny, Waterloo (CA); Brad Oldenburg, Waterloo (CA)

(73) Assignee: Magnum Semiconductor, Inc., Milpitas, CA (US)

(21) Appl. No.: 13/889,028

(22) Filed: May 7, 2013

(51) Int. Cl. H04N 19/88

(52) U.S. Cl. CPC H04N 19/00927
USPC 375/240.26

(57) ABSTRACT

Examples methods and apparatuses including a statistical multiplexer with the bitrate smoother are described herein. An example apparatus may include a statistical multiplexing (statmux) system for use with a communication link. The statmux system includes a bitrate smoother and a plurality of encoders. An encoder of the plurality of encoders is configured to provide a respective encoded bitstream of encoded coding units. The bitrate smoother is configured to select a group of encoded coding units. The selected group of encoded coding units includes encoded coding units of at least two different respective encoded bitstreams. The bitrate smoother further configured to adjust respective transmission timing of the selected group of encoded coding units. The adjusted respective transmission timing of the group of encoded coding units of the at least two different respective encoded bitstreams overlap during a time interval.

### TECHNICAL FIELD

Embodiments described relate to video encoding, and include a statistical multiplexer with bitrate smoothing to combine multiple channels.

### BACKGROUND

In content distribution environments, communication links may have a fixed bandwidth. The fixed bandwidth of a communication link is typically higher than the bandwidth needs of any single channel of media content provided from a content provider. Thus, content providers may pool encoded bitstreams of several channels together to maximize use of the bandwidth of the communication link. Modern block based video coding standards such as H.261, H.262, H.263 and H.264 take advantage of temporal and spatial redundancy of a channel to achieve efficient video compression, but produce variable bitrate (VBR) bitstreams. As complexity of content of the channel changes, the bitrates of the encoded bitstreams may vary over time. A quantification of complexity is often specific to a video coding methodology and an encoder used to encode the content. One issue with pooling encoded bitstreams of several channels is managing the variability of the bitrates of each encoded bitstream to efficiently use bandwidth of a constant bitrate communication link while maintaining consistent video quality on each channel.

A conventional implementation of managing bandwidth of a pool of encoded bitstreams may use a statistical multiplexer (statmux) system. The statmux system may include several encoders, a controller, and a multiplexer. The inputs to the encoders may be content channels to be encoded for the purpose of content distribution. Encoded bitstreams are provided from the several encoders to a multiplexer. The multiplexer may combine the encoded bitstreams into a multi-program transport stream (MPTS). On the receiving side, one or more encoded bitstreams are de-multiplexed from the MPTS using standard de-multiplexing techniques and decoded. A statmux system may be beneficial in this scenario since it can pool multiple channels together in such a way that the final bitstream has a continuous bitrate, which may be distributed over existing distribution networks.

A typical way of controlling bitrates of the individual encoders in a statmux system is to divide time into time slots having fixed periods, and to divide the available bandwidth of the communication link for a time slot between the channels by assigning a bitrate to each channel. Each encoder is likely to be producing different bitrates at different times, and on average, if the complexity of the content on one channel increases, the complexity of another channel's content might be reduced in the same time. The encoders then use local rate controllers to encode content based on the assigned bitrates for a time slot and information about the content received by the individual controller implementing rate control without exceeding the given limits to avoid exceeding a bandwidth of the communication link for the time slot.

### BRIEF DESCRIPTION OF THE DRAWINGS

FIG. 1 is a block diagram of a content distribution system including a statmux system with a bitrate smoother according to an embodiment of the disclosure;

FIG. 2 is a block diagram of a content distribution system including a statmux system with a bitrate smoother according to an embodiment of the disclosure;

FIG. 3 is a block diagram of a content distribution system including a statmux system with a bitrate smoother according to an embodiment of the disclosure;

FIGS. 4A and 4B are timing diagrams of a model output buffer and channel transmission bitrates associated with multiple channels according to an embodiment of the disclosure;

FIG. 5 is a flowchart for a method for smoothing a transmission bitrate associated with individual channels according to an embodiment of the disclosure

FIG. 6 is a schematic illustration of a media delivery system according to an embodiment of the disclosure; and

FIG. 7 is a schematic illustration of a video distribution system that may make use of a media delivery system described herein.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in, order to avoid unnecessarily obscuring the disclosure.

There may be potential complexities associated with the conventional statmux setup described above. One potential complexity is related to a burst output of a frame of a channel. In the conventional statmux system, the controller provides control signals to a multiplexer. Based on the transmit information, the multiplexer is configured to output frames from respective channels. Typically, the transmit information is set to cause the multiplexer to output an entire frame associated with a channel in a continuous burst of packets. In order to efficiently use bandwidth of the communication link, the burst rate of the packets is associated with the constant bitrate of the communication link. After the encoded frame associated with the channel is output, encoded frames associated with other channels may be subsequently output from the multiplexer. During that time, the output bitrate associated with an encoder of a channel not currently transmitting a frame is zero. Thus, in the short term, the bitrate for any given channel at one time may either be zero or the bitrate of the communication link for a duration of a encoded frame (or other encoded encoders and decoders are designed for certain bitrate limits. Thus, while the average bitrate associated with a channel as calculated over multiple frames may be within limits of an encoder or decoder, the burst rate at the communication link rate for a single frame may exceed bitrate limits of the encoders or decoders.

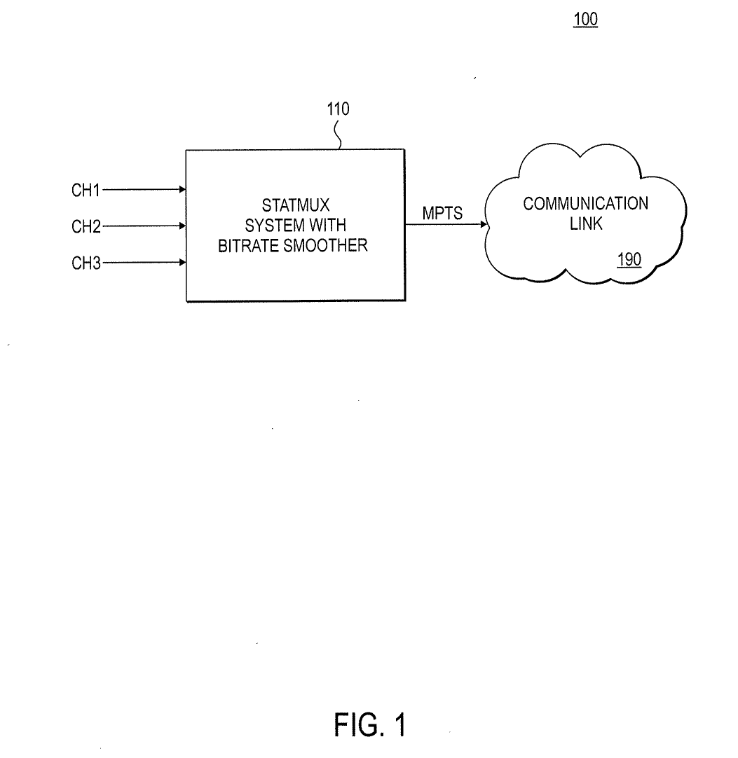

FIG. 1 is a block diagram of a content distribution system 100 including a statistical multiplexer (statmux) with a bitrate smoother (RC) 110 according to an embodiment of the disclosure. The content distribution system 100 may be implemented in hardware, software, firmware, or combinations thereof, and may include control logic, logic gates, processors, memory, and/or any combination or sub-combination of the same, and may be configured to encode and/or compress one or more CH0-N channels to provide one or more encoded bitstreams using one or more encoding techniques, and to combine the one or more encoded bitstreams into a multi-program transport stream (MPTS) to provide over a communication link 190.

The statmux with the bitrate smoother 110 may include one or more encoders and the bitrate smoother. As explained above, the statmux with the bitrate smoother 110 may receive coding units via the respective CH0-N channels, and generate encoded bitstreams based on the coding units using one or more encoding techniques. Examples of coding units may include frames, sub-frames, regions, macroblocks, etc. In the interest of clarity, operation of the statmux with the bitrate smoother 110 will discussed in terms of frames as coding units, although in other examples other coding units may be used. The encoded bitstreams may be variable bitrate bitstreams, with variance based on, for example, a complexity of the encoded frames of content of the respective CH0-N channels. The statmux with the bitrate smoother 110 may select a group of (e.g., at least two) encoded frames that include encoded frames from at least two different CH0-N channels and may expand transmission timing associated with the selected group of encoded frames. Expanding the transmission timing associated with the selected group of encoded frames generally refers to adjusting the timing of transmission such that the entire frame may not be transmitted continuously at the fixed bit rate of the communication link. Instead, portions of the encoded frame may be transmitted at the fixed bit rate of the communication link and, in between the portions, portions of other frames may be transmitted. Accordingly, the time from when a frame begins to be transmitted until the time the last data from the encoded frame is transmitted may be longer than if the encoded frame had been transmitted all at once. However, the average transmission rate may not violate a maximum acceptable rate for an encoder or decoder in the system. In this manner, expanding the transmission timing may include overlapping transmission timing among the selected group of encoded frames from different channels over a time interval. The statmux with the bitrate smoother 110 may combine the encoded bitstreams into the MPTS based on the expanded transmission timing and provide the MPTS to the communication link 190. Recall the communication link 190 may have a fixed bandwidth.

In operation, the statmux with the bitrate smoother 110 may manage encoding and combining of the CH0-N channels into the MPTS to be transmitted over the communication link 190. Generally, the statmux with the bitrate smoother 110 may utilize rate control to determine a quality level at which to encode each of the associated channels. Rate control generally refers to the use of information about more than one channel in determining a quality at which to encode a single channel. The statmux with the bitrate smoother 110 may also smooth a bitrate of individual channels CH0-N. For example, the statmux with the bitrate smoother 110 may select a group of encoded coding units associated with the channels CH0-N and expand transmission times associated with each encoded coding unit of the selected group of encoded coding units. Expanding the transmission timing may result in transmission of packets of an encoded coding unit of the selected group of encoded coding units interleaving with transmission of packets of other encoded coding units of the selected group of encoded coding units over a time interval. Because a transmission rate is determined based on a frequency and size of packets, interleaving packets of at least two encoded coding unit m with each other may reduce peak transmission bitrate of each of the selected group of encoded coding units over a time interval as compared with sending a burst of packets of an encoded coding unit consecutively at the target bitrate.

In encoding of the encoded coding units, a rate controller may provide a quality parameter (QP) to each of the encoders having a value based on statistical information related to encoded coding units. The value of the QP provided to each of the encoders may be based on statistical information from more than one channel, including more than just the channel with which the encoder is associated. The encoders may encode coding units of an associated CH0-N channel based on the provided QP and provide the encoded coding units in a respective encoded bitstream. The encoding methodologies for each encoder may result encoded frames of the respective CH0-N channel having variable bitrates. The statmux with the bitrate smoother 110 may combine the encoded bitstreams provided from each of the encoders into the MPTS and provide the MPTS at an output over the communication link 190.

The combination of the encoded bitstreams in the MPTS may be controlled by the bitrate smoother. For example, the rate controller may provide control signals that include respective transmit information related to transmission of associated encoded coding units of the encoded bitstreams. For a given encoded coding unit, the respective transmit information may include transmission timing. The bitrate smoother may select a group of encoded coding units based on the transmit information. The selected group of encoded coding units may be consecutive encoded coding units. The transmission timing associated with each of the selected group of encoded coding units may be expanded over a time interval based on the transmit information of each individual coding unit. Expanding the transmission timing may include adjusting the transmission time of portions of each encoded coding unit of the selected group of encoding units such that the portions of encoded coding units of different channels are interleaved during transmission. The bitrate smoother may provide the respective transmit information including the expanded transmission timing to a multiplexer via the control signals.

The multiplexer of the statmux with the bitrate smoother 110 may packetize each encoded coding unit of the selected group of coded coding units into two or more packets. The multiplexer may transmit the packets of each encoded coding units of the selected group of encoded coding units based on the respective transmit information with the expanded transmission timing. As explained above, the transmission timing includes transmission times for portions of the encoded coding units such that portions of the encoded coding units of different channels are interleaved. Interleaving the encoded coding unit packets of the selected group of coding units may smooth a bitrate of an encoded coding unit by reducing a frequency of packets of the encoded coding unit as compared with sending the packets of the encoded coding unit in a consecutive burst at the target bitrate. Thus, while the data in a single packet may still be transmitted at the communication link bitrate, a bitrate calculation based on the transmission time of consecutive packets may be within limits of the decoder.

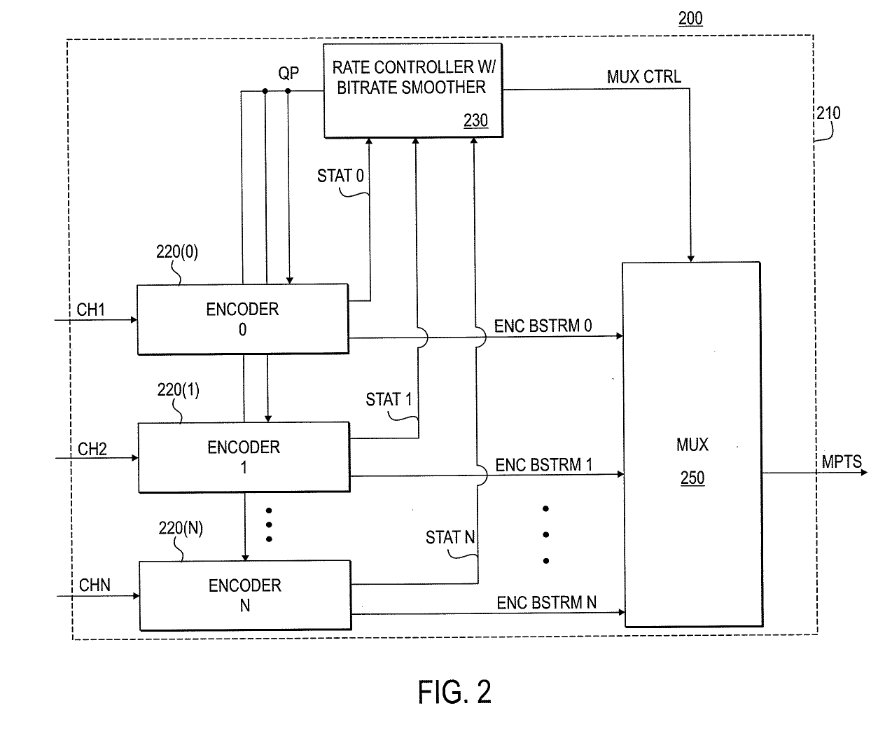

FIG. 2 is a block diagram of a statistical multiplexer (statmux) system 200 including a statmux with a bitrate smoother 210 according to an embodiment of the disclosure. The statmux with the bitrate smoother 210 may be implemented in hardware, software, firmware, or combinations thereof, and may include control logic, logic gates, processors, memory, and/or any combination or sub-combination of the same, and may encode and/or compress respective frames of the CH0-N channels to provide one or more encoded bitstreams 0-N using one or more encoding techniques, and to combine the encoded bitstreams 0-N into a multi-program transport stream (MPTS) signal. The statmux with the bitrate smoother 210 may be used to implement the statmux with the bitrate smoother 110 of FIG. 1.

The statmux with the bitrate smoother 210 may include a rate controller (RC) with bitrate smoother 230. The RC with bitrate smoother 230 may receive statistical information STAT 0-N associated with encoded coding units of the respective CH0-N channels from one or more of the encoders 0-N 220(0-N). As explained above, examples of coding units may include frames, sub-frames, regions, macroblocks, etc. In the interest of clarity, operation of the statmux with the bitrate smoother 210 will discussed in terms of frames as coding units, although other coding units may be used in other examples. The STAT 0-N information may include information regarding encoded frames, such as but not limited to, information indicating an actual size of an encoded frame, unquantized frame size, complexity information based on a quality parameter, or combinations thereof. In some embodiments, the RC with bitrate smoother 230 may be implemented using rate control methods and rate controllers as described in U.S. patent application Ser. No. 13/886,047 filed on May 2, 2013, which is incorporated herein by reference in its entirety for any purpose.

The RC with bitrate smoother 230 may analyze the STAT 0-N information from the encoders 0-N 220(0-N) to select a quality parameter (QP) value. In some embodiments, the RC with bitrate smoother 230 may model a level (e.g. amount of data) of a model output buffer based on the combined encoded bitstreams 0-N associated with the CH0-N channels. The model output buffer may have a target constant bitrate output. The target constant bitrate output may be based on a constant bitrate of the communication link. The RC with bitrate smoother 230 may provide the selected QP value to the encoders 0-N 220(0-N) having a value based on the statistical information and based on the level of the model output buffer.

The RC with bitrate smoother 230 may be further configured to determine transmit information used to control output of an encoded frame based on associated STAT 0-N information and based on a level of the model output buffer associated with the encoded frame. The transmit information associated with an encoded frame may include a decode time stamp (DTS), a transmit begin time, a transmit end time, and/or a size of the encoded frame. The DTS may represent a time when the associated frame is to be removed from the model, output buffer. The transmit begin time may represent a time when a first bit of the associated frame is to be released to the output and the transmit end time may represent a time when the last bit of the associated encoded coding unit is to be released to the output. Based on the transmit information associated with encoded frames, the RC with bitrate smoother 230 may select a group of (e.g., at least two) encoded frames to be transmitted together (e.g. interleaved) over a time interval. The RC with bitrate smoother 230 may adjust (e.g. expand) transmission timing associated with each of the selected group of encoded coding units based on the time interval, the transmit information associated with each individual coding unit, and the level of the model output buffer. The bitrate smoother may provide the respective transmit information including the expanded transmission timing to the multiplexer 250 via control signals MUX CTRL.

The encoders 0-N 220(0-N) may receive respective coding units via the respective CH0-N channels and provide respective frames via the encoded bitstreams 0-N at an output of each of the respective encoders. The encoders may be implemented in hardware, software, or combinations thereof. The encoders 0-N 220(0-N) may include respective entropy encoders, such as a variable-length coding encoder (e.g., Huffman encoder, context-adaptive variable length coding (CAVLC) encoder, or context-adaptive binary arithmetic coding (CABAC) encoder), and/or may encode the frames, for instance, at a macroblock level. Each macroblock may be encoded in intra-coded mode, inter-coded mode, bidirectionally, or in any combination or subcombination of the same. As an example, the encoders 0-N 220(0-N) may receive and encode frames via the respective CH0-N channels. The respective CH0-N channels may be encoded in accordance with one or more encoding algorithms or standards, such as MPEG-2, MPEG-4, H.263, H.264, and/or HEVC. The encoding methodologies and/or standards implemented by each encoder 0-N 220(0-N) may result in encoded frames having variable bitrates. The encoders 0-N 220(0-N) may further provide the respective STAT 0-N information to the RC with bitrate smoother 230. The respective STAT 0-N information may be based on a respective encoded frame.

The statmux with the bitrate smoother 210 may further include the multiplexer 250 configured to receive the encoded bitstreams 0-N from the respective encoders 0-N 220(0-N). The multiplexer 250 may packetize and transmit the encoded bitstreams 0-N into the MPTS based on the adjusted transmit information in the MUX CTRL signals received from the RC with bitrate smoother 230, and to provide the MPTS to the communication link.

In an example operation, the RC with bitrate smoother 230 may manage transmission of encoded bitstreams 0-N having variable bitrates via the MPTS over a communication link. The communication link may have a fixed bandwidth (e.g., and a constant bitrate). The RC with bitrate smoother 230 may select a QP value to provide to the encoders based on the STAT 0-N information received from one or more of the encoders 0-N 220(0-N) and based on the level of the model output buffer, which has an associated target bitrate.

The RC with bitrate smoother 230 may also determine transmit information associated with each frame of the encoded bitstreams 0-N based on the respective STAT 0-N information. Based on the transmit information associated with each encoded frame, the RC with bitrate smoother 230 may select a group of encoded frames (e.g. at least two encoded frames), which includes encoded frames of two or more encoded bitstreams 0-N. The RC with bitrate smoother 230 may adjust the transmission timing associated with each of the selected group of encoded frames based on the target bitrate and the respective transmit information. Adjusting the transmission timing may include interleaving the transmission of portions of encoded frames of the selected group of encoded frames of different encoded bitstreams 0-N over a time interval.

The respective transmit information including the adjusted transmission timing associated with the selected group of encoded frames may be provided to the multiplexer 250 via the MUX CTRL signals. The adjusted transmission timing may cause the multiplexer 250 to interleave packets of an encoded frame of the selected group of encoded frames with packets of other encoded frames of the selected group of encoded frames. Adjusting the transmission timing of an encoded frame by interleaving transmission of the encoded frame with other encoded frames may reduce resulting bitrate variations of a single encoded bitstream 0-N. For example, reducing a transmission frequency of packets of an encoded frame by interleaving transmission of the packets of the encoded frame with transmission of packets of other encoded frames may reduce a bitrate associated with the encoded frame as compared with bursting transmission of the packets of the encoded frame consecutively at the target bitrate.

In encoding the encoded frames, each of the respective encoders 0-N 220(0-N) may receive respective frames via the corresponding CH0-N channel. Responsive to receipt of respective frames, the encoders 0-N 220(0-N) may encode the received respective frames based on the QP value selected by the RC with bitrate smoother 230. In some examples, the RC with bitrate smoother 230 may select a single QP value for use by all or multiple encoders. In other examples, the RC with bitrate smoother 230 may provide different QP values to different ones of the encoders. The encoded frames may be provided in the respective encoded bitstreams 0-N to the multiplexer 250. Responsive to encoding each respective frame, the associated encoder 0-N 220(0-N) may provide updated respective STAT 0-N information to the RC with bitrate smoother 230. Examples of STAT 0-N information associated with a respective frame may include an actual encoded frame size, complexity information, un-quantized encoded frame size information, and combinations thereof.

Responsive to receiving the updated STAT 0-N information from the respective encoder 0-N 220(0-N), the RC with bitrate smoother 230 may perform a QP selection process. During the QP selection process, the RC with bitrate smoother 230 may update a level of the model output buffer based on an actual size of an encoded frame received in the updated STAT 0-N information and/or the level of the model output buffer. Further, the RC with bitrate smoother 230 may analyze the updated STAT 0-N information to select a QP value.

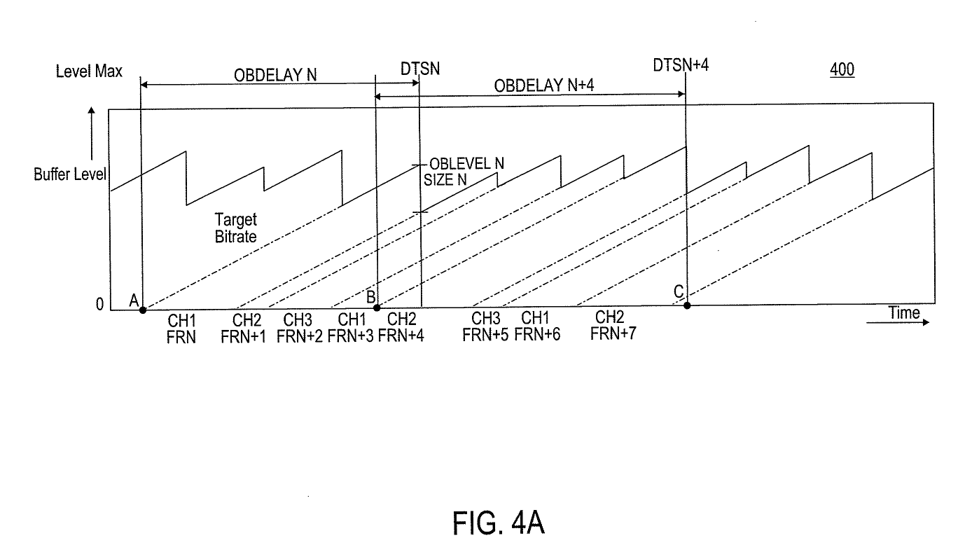

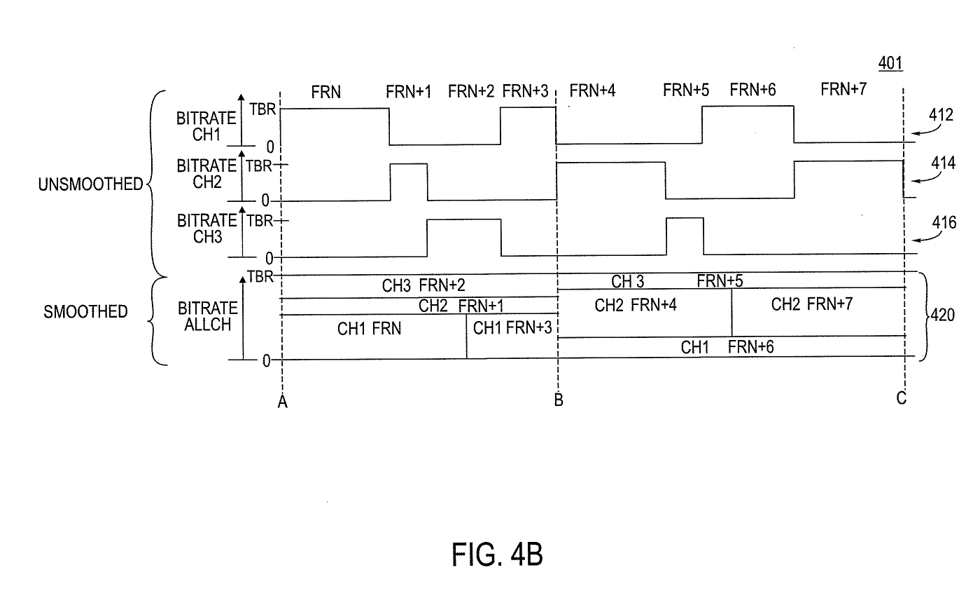

The multiplexer 250 may packetize the encoded frame into a series of packets. The multiplexer 250 may time multiplex packets of a selected group of encoded frames of the encoded bitstreams 0-N into the MPTS based on the respective transmit information including the expanded transmission timing received via the MUX CTRL signals. For example, for an encoded frame, the multiplexer 250 may interleave packets of the selected group of encoded frames over time between the transmit begin time and the transmit end time based on the number of packets, and the size of each packet. Typically, the transmit begin time and the transmit end time may be set based on the length of time necessary to transmit the encoded frame in a single burst of packets at the target bitrate. The target bitrate may be much greater than a bitrate required to transmit any single channel, and may exceed bitrate limits of an encoder 0-N 220(0-N) or a decoder (not shown). Thus, while the average transmission bitrate computed across two or more encoded frames of an encoded bitstream 0-N that are separated by encoded frames of other encoded bitstreams 0-N may be within limits of encoder 0-N 220(0-N) or a decoder, transmitting packets of a single encoded frame consecutively in a burst at the target bitrate may exceed the bitrate limits of the encoder 0-N 220(0-N) or a decoder. A comparison of bursting packets for a frame consecutively versus interleaving packets of different frames is described further herein with reference to FIGS. 4a and 4b.

For example, assuming a target bitrate of the communications link is 40 megabytes per second (MBPS) and assuming the statmux with bitrate smoother 210 encodes four identical channels, with each encoder 0-N 220(0-N) capable of providing an encoded bitstream having a 10 MBPS bitrate, an average transmission bitrate for each encoded bitstream would be 10 MBPS (e.g., because each channel is identical and would consume one-fourth of the target bitrate). However, when packets of an encoded frame are transmitted in a burst consecutively at the target bitrate, the bitrate of a single encoded bitstream would be 40 MBPS during transmission of packets of an encoded frame, and would be 0 MBPS while packets of encoded frames of the other three channels are being transmitted. Thus, the bitrate variation ranges from 40 MBPS to 0 MBPS over one second in time, but averages out to 10 MBPS. As explained above, the encoders 0-N 220(0-N) and or decoders receiving the encoded bitstream may be incapable of receiving a burst of packets of an encoded frame at the 40 MBPS.

As explained above, by adjusting the time between the transmit begin time and the transmit end time, the average rate of transmission of packets for an encoded frame of a selected group of encoded frames may be reduced, which may also smooth the bitrate of each encoded bitstream 0-N. The multiplexer 250 may interleave transmission of packets of the selected group of encoded frames from different channels.

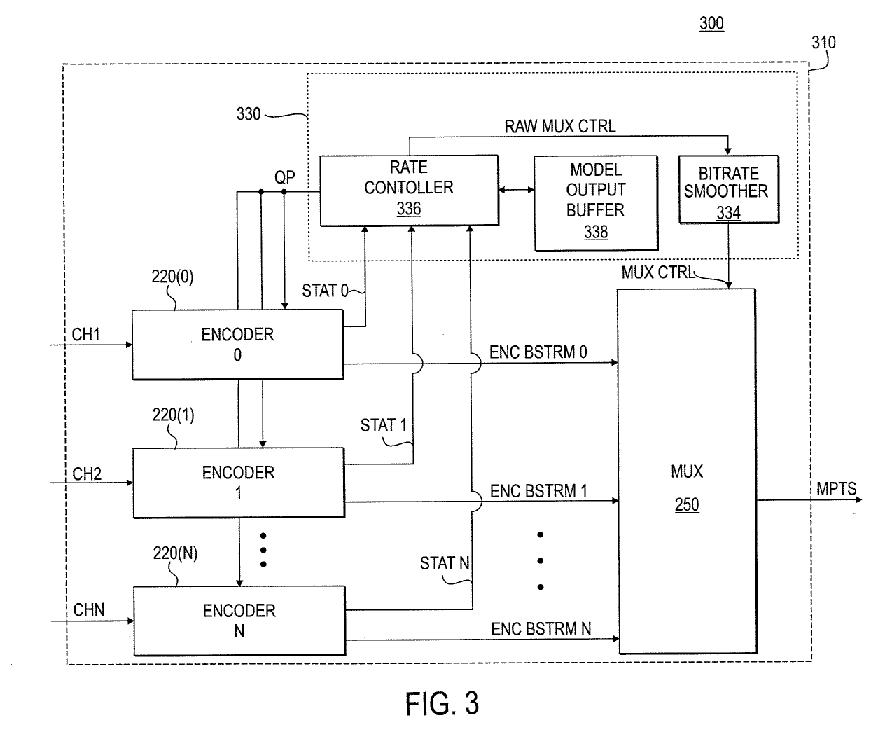

Accordingly, examples of bitrate smoothers described herein may select a group of encoded frames (or other coding units), that may be interleaved together for transmission over a time interval. The selection of the group of encoded frames may be based on selection conditions that may include evaluating the respective transmit information and the level of the model output buffer. The bitrate smoother may evaluate encoded frames against selection conditions, and may continue to add encoded frames to the selected group until a selection condition fails. Selection of encoded frames to be included in the selected group of encoded frames is described further with reference to FIG. 3.

A time interval associated with the selected group of encoded frames may be determined based on respective transmit information associated with the selected group of encoded frames and in accordance with the selection criteria described further herein. Once the selected group of encoded frames is selected, the RC with bitrate smoother 230 may adjust the transmission timing for packets of each encoded frame of the group based on the length of the time interval, the aggregate size of the selected frames, and the relative sizes of each of the encoded frames. In some examples, adjusting the transmission timing may include adjusting the transmit begin time and the transmit end time associated with each encoded frame of the selected frames such that the transmission timing among the encoded frames of the group from different encoded bitstreams 0-N overlap within the time interval.

The above example operation is provided for illustrative purposes, and is not intended to limit the disclosure. As explained above, while the description of operation the statmux with the bitrate smoother 210 is based on encoding of frames, it will be appreciated that operation of the statmux system 200 may be based on encoding of coding units, such as macroblocks, and/or other sub-coding units, such as portions of a frame, and the encoded coding units or encoded sub-coding units may be provided to the multiplexer 250 via the respective encoded bitstreams 0-N. It will be appreciated that, while FIG. 2 depicts three encoders, a statmux with the bitrate smoother 210 may include 2, or more than three encoders. The encoders 0-N 220(0-N) may have different architecture and/or may encode the encoded frames of the respective CH0-N channels using different encoding methodologies or standards, and may operate at different rates. In some embodiments, the RC with bitrate smoother 230 may operate at least as fast as a channel of the CH0-N channels having a fastest frame rate. It will be appreciated that encoding of channels may include other dependencies beyond bitrates and timing.

Further, it will also be appreciated that the RC with bitrate smoother 230 may provide a different QP to each of the encoders 0-N 220(0-N). For example, the QPs may be assigned as follows: (1) QP deltas can be applied to individual channels of the CH0-N to introduce quality differences between the individual channels (e.g., premium channels with higher quality may be guaranteed a QP that achieves a quality a predetermined amount greater than one or more other channels); (2) fixing a QP for one or more of the CH0-N channels (e.g., a guaranteed quality of the one or more channels); (3) assigning minimum and maximum quality limits for one or more channels, which may be a more reliable way than specifying minimum and maximum bitrates, in some examples; (4) using non-linear quality control to limit changing a QP value for a particular channel or channels relative to changing QP for other channels; and (5) quality balancing between different encoders 0-N 220(0-N) of the same and different compression formats and different encoder's configurations within the statmux system 200. It will also be appreciated the one or more encoded bitstreams 0-N may be excluded from having adjusted transmission timing via the bitrate smoother 334.

FIG. 3 is a block diagram of a statistical multiplexer (statmux) system 300 including a statmux with a bitrate smoother 310 according to an embodiment of the disclosure. The statmux with the bitrate smoother 310 may be implemented in hardware, software, firmware, or combinations thereof, and may include control logic, logic gates, processors, memory, and/or any combination or sub-combination of the same, and may encode and/or compress respective frames of the CH0-N channels to provide one or more encoded bitstreams 0-N using one or more encoding techniques, and to combine the encoded bitstreams 0-N into a multi-program transport stream (MPTS) signal. The statmux with the bitrate smoother 310 includes elements that have been previously described with respect to the statmux with the bitrate smoother 210 of FIG. 2. Those elements have been shown in FIG. 3 using the same reference numbers used in FIG. 2 and operation of the common elements is as previously described. Consequently, a detailed description of the operation of these elements will not be repeated in the interest of brevity. The statmux with the bitrate smoother 310 may be used in the statmux with the bitrate smoother 110 of FIG. 1 and/or the statmux with the bitrate smoother 210 of FIG. 2.

The statmux with the bitrate smoother 310 may include the RC with bitrate smoother 330. The RC with bitrate smoother 330 may include a rate controller 336 coupled a model output buffer 338 and to a bitrate smoother 334. The rate controller 336 may receive statistical information STAT 0-N associated with encoded coding units of the respective CH0-N channels from one or more of the encoders 0-N 220(0-N). The STAT 0-N information may include information indicating an actual size of an encoded coding unit, quantization information based on a quality parameter, or combinations thereof. As explained with reference to FIG. 2, examples of coding units may include frames, sub-frames, regions, macroblocks, etc. In the interest of clarity, operation of the statmux with the bitrate smoother 310 will discussed in terms of frames as coding units, although other coding units may be used in other examples. Based on the STAT 0-N information, the rate controller 336 may update a level of the model output buffer 338 by adding actual encoded frame sizes to the model output buffer 338. The rate controller 336 may further provide a raw multiplexer control signal RAW MUX CTRL having transmit information associated with an encoded frame based on the associated STAT 0-N information and based on an amount of data in (e.g., a level of) the model output buffer 338. As explained with reference to FIG. 2, the transmit information may include a decode time stamp (DTS), a transmit begin time, a transmit end time, and/or an encoded frame size.

The model output buffer 338 may be a physical buffer or may be a software model including a representation of an amount of data contained in (e.g., a level of) a modeled output buffer. The model output buffer 338 may model an output buffer having a target bitrate. In some embodiments, the target bitrate may be based on or may be equal to a constant bitrate of the communication link. A level of the model output buffer may be changed based on a size of an encoded frame received via the STAT 0-N information from the encoders 0-N 220(0-N) (e.g., changing the level in a first direction based on the actual encoded frame size), while the level of the model output buffer 338 is continuously changing in a second direction at the target bitrate. In some embodiments, the first direction is increasing the level and the second direction is decreasing the level. In other embodiments, the first direction is decreasing the level and the second direction is increasing the level. The model output buffer 338 may provide a present level to the rate controller 336. Additionally, based on the present level of the model output buffer 338 and the STAT 0-N information from the encoders 0-N 220(0-N) select a QP that results in the level of the model output buffer 338 staying within a target range (e.g. not filled over a maximum threshold and not depleted below a minimum threshold).

The bitrate smoother 334 may be configured to select a group of encoded frames. The selected group of encoded frames may include encoded frames from at least two different encoded bitstreams 0-N. The bitrate smoother will interleave packets from the selected group of encoded frames for transmission over a time interval. To accomplish this, the bitrate smoother may adjust transmission timing (e.g. a time at which packets are scheduled for transmission). The adjusted transmission timing may result in overlapping transmission timings among portions of (e.g. packets of) the selected group of encoded frames. The bitrate smoother 334 may adjust the transmission timing by adjusting the transmit information associated with each of the selected group of encoded frames based on the time interval and based on the transmit information of each individual encoded frame of the selected group of encoded frames. The bitrate smoother may provide the respective transmit information including the adjusted transmission timing associated with the selected group of encoded frames to the multiplexer 250 via control signals MUX CTRL.

In an example operation, the RC with bitrate smoother 330 may manage transmission of encoded bitstreams 0-N having variable bitrates via the MPTS over a communication link. The communication link may have a fixed bandwidth (e.g., and a constant bitrate). The RC with bitrate smoother 330 smooth transmission bitrates of one or more encoded bitstreams 0-N by adjusting transmission timing of portions of encoded frames from the selected group of encoded frames. Adjusting transmission timing may include an interleaving packets between encoded frames from different encoded bitstreams 0-N. As compared with a bitrate associated with transmitting packets of a single frame in a burst consecutively, interleaving packets of two or more encoded frames may reduce a frequency of packets of an individual encoded frame, which may result in a reduced respective bitrate associated with the associated encoded bitstream 0-N. The multiplexer 250 may packetize and transmit each encoded frame of the selected group of encoded frames based on the adjusted transmit information.

As explained with reference to FIG. 2, each of the respective encoders 0-N 220(0-N) may encode the respective received frames based on the QP value selected by the rate controller 336. The encoded frames may be provided in the respective encoded bitstream 0-N to the multiplexer 250. The multiplexer 250 may time multiplex the encoded bitstreams 0-N into the MPTS based on the adjusted transmit information provided in the MUX CTRL signal from the bitrate smoother 334.

Responsive to receiving the updated STAT 0-N information, the rate controller 336 may perform a QP selection operation. The QP selection operation may include the rate controller 336 providing an actual size of the encoded frame included in the updated STAT 0-N information to the model output buffer 338. The model output buffer 338 may update the buffer level based on the actual size of an encoded frame received from the rate controller 336. The QP selection process may include the rate controller 336 selecting a QP value based on the level of the model output buffer 338 and the STAT 0-N information received from the encoders (0-N) 220(0-N).

The rate controller 336 may determine transmit information associated with each respective encoded frame of the encoded bitstreams 0-N based on the STAT 0-N information and based on the level of the model output buffer 338. As explained with reference to FIG. 2, typically, the transmit begin time and the transmit end time of the transmit information may be set based on the length of time necessary to transmit the encoded frame in a single burst of packets at the target bitrate. In some embodiments, the transmit begin time and the transmit end time may be calculated based on the DTS, the size of the encoded frame (e.g., size), the level of the model output buffer 338 corresponding to the encoded frame (e.g. OBlevel), and the target bitrate. For example, a model output buffer 338 delay (e.g., OBdelay) may be OBlevel/the target bitrate. Further, a transmit duration of the encoded frame (e.g., duration) may be the size/the target bitrate. The transmit begin time T1 may be DTS−OBdelay. The transmit end time may be T1+duration.

The transmit information may be provided to the bitrate smoother 334 in the RAW MUX CTRL signal. As explained above, the bitrate smoother 334 may smooth the bitrate of one or more encoded bitstreams 0-N provided in the MPTS at the output of the multiplexer 250 by providing transmit information including adjusted transmission timing to the multiplexer 250 via the MUX CTRL signal. The transmit information including the adjusted transmission timing may reduce a frequency of packets of an encoded frame of selected group of encoded frames associated with an encoded bitstream 0-N by interleaving encoded frames of the selected group of encoded frames with other encoded frames of the selected frames from different channels.

The selection of the group of encoded frames by the bitrate smoother 334 may be based on selection conditions. The selection conditions may include evaluating the respective transmit information associated with consecutive encoded frames and a respective level of the model output buffer 338 when the associated encoded frame is added to the model output buffer 338. In some embodiments, selecting the group of encoded frames may include adding, starting with initial encoded frame N, consecutive subsequent encoded frames until a prospective ith frame meets one of the following selection conditions:
1. (DTSᵢ−A)>maxOBdelay
2. (DTSᵢ−OBdelayᵢ)>DTS_{N}
3. (DTSᵢ−DTS_{N})>maxSearchPeriod

wherein, DTSi is the decode time stamp (DTS) of the next prospective encoded frame i to be added; A is the start of the time interval (e.g., the transmit begin time of the initial encoded frame N or DTS_{N}−Obdelay_{N}); maxOBdelay is a configurable parameter defining a maximum delay of the model output buffer 338; OBdelay, is the model output buffer 338 delay associated with the next prospective encoded frame i (e.g., output buffer 338 levelᵢ divided by the target bitrate), DTS_{N} is the DTS of the initial encoded frame N; and maxSearchPeriod is a maximum search window for selecting encoded frames for the selected group of encoded frames.

The first comparison (e.g., (DTSᵢ−A)>maxOBdelay) terminates further additions to the group of encoded frames when a next prospective encoded frame to be added has a decode time stamp that is above a threshold (e.g. equal to or greater than maxOBdelay) future time away from the start of the time interval. All encoded frames in the selected group of encoded frames may have packets which may begin transmission at or around time A. If the difference between the decode time stamp (e.g. the time at which the encoded frame will be decoded) and the time A is too great, the data may spend too long in the model output buffer and/or in a buffer at a decoder, risking overflow. Accordingly, only packets have a DTS within a threshold time from the start of the time interval may be included. In this manner, the maxOBDelay may serve to prevent from overflowing a buffer at a decoder (e.g., by becoming too close to a previous encoded frame of the same channel).

The second comparison (e.g., (DTSᵢ OBdelayᵢ)>DTS_{N}) may terminate further additions to the selected group of encoded frames when the next prospective encoded frame i has a decode timestamp greater than the decode timestamp of the initial encoded frame N plus a threshold delay related to the model output buffer 338. This may prevent adding the next prospective encoded frame i to the group if the next prospective encoded frame i is incapable of being output from the model output buffer 338 prior to the DTS of the initial encoded frame N. Otherwise, interleaving the initial encoded frame N with the next prospective encoded frame i having a decode time stamp too far in the future may cause the initial encoded frame N to be spread too far out, resulting in an inability to decode the encoded frame by the required decode time stamp.

The third comparison (e.g., (DTSᵢ−DTS_{N})>maxSearchPeriod) may set a configurable time limit for the selection process. This may avoid devoting too much time to the selection process and/or place an upper limit on the number of encoded frames to be included in the group.

Generally, any number of encoded frames may be selected in a group for interleaving that meet the above-described selection criteria in some examples. In examples of the present disclosure the group may include at least two, including 2, 3, 4, 5, 6, 7, 8, 9, or 10 encoded frames may be selected in the group. In other examples, a greater number of encoded frames may also be selected.

The bitrate smoother 334 may determine a time interval associated with the selected group of encoded frames starting at the transmit begin time (e.g., time A) of the initial encoded frame N and extending to a transmit end time (e.g., time B) of a last frame N+X of the selected group of encoded frames. The bitrate smoother 334 may expand the time interval over which any given encoded frame is transmitted by adjusting the respective transmit begin times and the respective transmit end times within the transmit interval time A to time B. The bitrate smoother 334 may update the transmit begin times and the transmit end times for each of the encoded frames of the selected group of encoded frames to values that overlap with values of other encoded frames of the selected group of encoded frames between time A and time B. In an embodiment, the transmit begin times and transmit end times for consecutive encoded frames of the selected group of encoded frames may be staggered based on the size of the packets provided by the multiplexer 250, the target bitrate, and the relative sizes of the encoded frames of the selected group of encoded frames. Packets of the encoded frames in the selected group of encoded frames may be interleaved across the time interval.

In an example, the selected group of encoded frames may include X encoded frames all having a same size and from different encoded bitstreams 0-N. The size of the packets provided by the multiplexer may be P. For the initial encoded frame N, the transmit begin time T1_{N} may be time A, and the transmit end time T2_{N} may be time B−((P/the target bitrate)*X). For the second encoded frame N+1, the transmit begin time T1_{N+1} may be time A+((P/the target bitrate)*1), and the transmit end time T2_{N+1} may be time B−((P/the target bitrate)*(X−1)). For the second to last encoded frame N+X−1, the transmit begin time T1_{N+X-1} may be time A+((P/the target bitrate)*X−1), and the transmit end time T2_{N+X-1} may be time B−((P/the target bitrate)*(1)). For the last encoded frame N+X, the transmit begin time T1_{N+X} may be time A+((P/the target bitrate)*X), and the transmit end time T2_{N+X} may be time B.

It will be appreciated that the above example is not intended to be limiting. The above example assumes that the size of each encoded frame of the selected group of encoded frames is the same, which may not be the case in all examples. If the sizes of the encoded frames of the selected group of encoded frames vary, the staggering of the transmit begin times and the transmit end times may vary accordingly. For example, if one or more encoded frames are larger than one or more other encoded frames of the selected group of encoded frames, the stagger between the one or more encoded frames and one or both adjacent encoded frames may be Y*(P/the target bitrate), where Y is an integer greater than one.

Further, if the selected group of encoded frames includes two or more encoded frames from the same channel 0-N, the transmit times for the encoded frames of the same encoded bitstream 0-N may not overlap, to avoid risk of overflowing a buffer at a decoder. Thus, the transmit begin times and the transmit end times for encoded frames of the same channel may be prorated based on the relative sizes of the encoded frames. For example, if two encoded frames of the same encoded bitstream 0-N included in the selected group of encoded frames have the same size, the transmit begin time for the first encoded frame will be near time A and the transmit end time will be approximately halfway between time A and time B. The transmit begin time for the second encoded frame may be approximately halfway between time A and time B, but after the transmit end time of the first encoded frame of the same encoded bitstream 0-N, and the transmit end time may be near time B.

The above example operation is provided for illustrative purposes, and is not intended to limit the disclosure. As explained above, while the description of operation of the statmux with the bitrate smoother 310 is based on encoding of frames, it will be appreciated that operation of the statmux system 300 may be based on buffering and encoding of coding units, such as macroblocks, and/or other sub-coding units, such as portions of a frame, and the encoded coding units or encoded sub-coding units are provided to the multiplexer 250 via the respective encoded bitstreams 0-N. It will be appreciated that, while FIG. 3 depicts three encoders, a statmux with the bitrate smoother 310 may include 2, or more than three encoders. The encoders 0-N 220(0-N) may have different architecture and/or may encode the encoded frames of the respective CH0-N channels using different encoding methodologies or standards, and may operate at different rates. In some embodiments, the elements of the RC with bitrate smoother 330 may operate at a rate least as great as a frame (e.g., or coding unit) rate of a channel of the CH0-N channels having a highest frame (e.g., or coding unit) rate.

Further, it will be appreciated that the logical connections between elements of the statmux with the bitrate smoother 310 may vary from the connections depicted in FIG. 3. For example, the actual encoded frame size may be provided directly to the model output buffer 338, rather than being provided via the rate controller 336. It will be appreciated that encoding of channels may include other dependencies beyond bitrates and timing.

FIGS. 4A and 4B are exemplary timing diagrams of a model output buffer and bitrate smoothing as described with reference to FIGS. 1-3. In the exemplary timing diagram 400, the horizontal axis represents time and the vertical axis represents a level of the model output buffer (e.g. an amount of data in the model buffer). The exemplary timing diagram 400 is depicted from a perspective of a decoder. Thus, rather than depicting new frames filling the model output buffer, new frames are instantaneously pulled/removed from the model output buffer (e.g., to be decoded). Further, rather than the model output buffer being drained the target constant bitrate, the model output buffer is filled at the target constant bitrate. An example of a selection of a group of encoded frames may include encoded frames FRN-FRN+7. The selection of the group of encoded frames based on the model output buffer depicted in the exemplary timing diagram 400 may be performed by the statmux with bitrate smoother 110 of FIG. 1, the statmux with the bitrate smoother 210 of FIG. 2, and/or the statmux with the bitrate smoother 310 of FIG. 3.

In the exemplary timing diagram 400, an exemplary buffer level is depicted being filled over time at the target bitrate with encoded frames FRN-FRN+7 being removed. The selection of the group of encoded frames may start with an initial encoded frame. In this example, the initial encoded frame is encoded frame FRN. The DTS_{N} identifies the time at which the encoded frame FRN will be removed from the model output buffer. As explained with reference to FIG. 3, based on the buffer level corresponding to frame N (e.g., OBlevel_{N}), the OBdelay_{N} can be determined (e.g., OBlevel_{N}/the target bitrate). Further, as explained with reference to FIG. 3, based on the size_{N} of the encoded frame FRN, the OBduration_{N} can be determined (e.g., size_{N}/the target bitrate). Based on the DTS_{N} and the OBdelay_{N}, the transmit begin time for encoded frame FRN can be determined, as identified by time A. Based on the transmit begin time at time A for the encoded frame FRN and the OBduration_{N}, the transmit end time for the encoded frame FRN can be determined (e.g., time when the dotted line subsequent to time A reaches the buffer level 0 line). OBdelay, OBduration, transmit begin times, and transmit end times associated with encoded frames FRN+1 FRN+7 may be determined similar to method used for the encoded FRN, e.g., based on the respective DTS, OBlevel and size. The determinations may be made by the statmux with bitrate smoother, such as the statmux with bitrate smoother 110 of FIG. 1, the statmux with bitrate smoother 210 of FIG. 2, and/or the statmux with bitrate smoother 310 of FIG. 3.

After identifying the DTS_{N} and the OBdelay_{N}, subsequent encoded frames FRN+1-FRN+7 may be evaluated by the bitrate smoother for inclusion in the selected group of encoded frames. As explained with reference to FIG. 3, an exemplary embodiment of selection criteria may include adding encoded frame to the selected group of encoded frames until reaching an encoded frame that satisfies one of the following conditions:
1. (DTSᵢ−A)>maxOBdelay
2. (DTSᵢ−OBdelayᵢ)>DTS_{N}
3. (DTSᵢ−DTS_{N})>maxSearchPeriod

Since conditions 1 and 3 may be based on set configurable parameters, the further discussion here will focus on condition 2. The DTS_{N+1} and OBdelay_{N+1} may be determined, e.g. by the bitrate smoother, as described above. The OBdelay_{N+1} is subtracted from the DTS_{N+1} and the result is compared with the DTS_{N}. Because the result is less than or equal to DTS_{N}, the encoded frame FRN+1 is included of the selected group of encoded frames. The encoded frames FRN+2 and FRN+3 may undergo a similar comparison and may be included of the selected group of encoded frames because the second condition is not satisfied (and assuming the configurable parameter conditions 1 and 3 are also not satisfied). For the encoded frame FRN+4, the comparison may fail because a result of subtracting the OBdelay_{N+4} from the DTS_{N+4} would be greater than the DTS_{N}. Thus, the encoded frame FRN+4 may be excluded from the selected group of encoded frames, and the selection process may terminate with the selected group of encoded frames including frames FRN-FRN+3. The time interval associated with the selected group of encoded frames may start with time A and end with the transmit end time associated with the last encoded frame FRN+3 (e.g., time B) As explained with reference to FIGS. 1-3, the transmit begin times and the transmit end times may be expanded to overlap for the encoded frames FRN-FRN+3 based on the time interval time A to time B, and based on the relative sizes of each of the encoded frames FRN-FRN+3. In the exemplary embodiment, FRN and FRN+3 are both from channel CH1. Thus, the expanded transmit begin times and the transmit end times the encoded frames FRN and FRN+3 may not overlap. Accordingly, the transition from transmitting FRN to transmitting FRN+3 along the time interval time A to time B being based on relative sizes of FRN and FRN+3.

After evaluating the encoded frames FRN-FRN+4 and adjusting the transmission timing for the encoded frames FRN-FRN+3, a new selection of a group of encoded frames begins with a next consecutive frame that was excluded from the previous selected group of encoded frames. In this example, the initial encoded frame may be the encoded frame FRN+4. As described above, the process selects the new selected group of encoded frames based on DTSs and OBlevels associated with subsequent frames until one of the three conditions fails. The second selection of a group of encoded frames may include the encoded frames FRN+4-FRN+7, and the time interval may be from time B to time C

FIG. 4B depicts an exemplary timing diagram 401 depicting exemplary transmission bitrates associated with channels CH1-3 in transmitting of the encoded frames FRN-FRN+7 from FIG. 4A with and without bitrate smoothing. During transmission without bitrate smoothing (e.g., unsmoothed), the high values of CH1 412, CH2 414, and CH3 416 represent the target bitrate TBR and the low values represent zero. Thus, between time A and time B, the encoded frames FRN-FRN+3 are sequentially transmitted, with a bitrate of the corresponding channel CH1-3 equal to the target bitrate TBR during transmission of a corresponding frame and a bitrate of zero when not transmitting an encoded frame. Similarly, between time B and time C, the encoded frames FRN+4-FRN+7 are transmitted

During transmission with bitrate smoothing (e.g., smoothed), the high value of the communication link 420 represents the target bitrate TBR and the low values represent zero. As depicted, between time A and time B, each channel CH1-3 has a respective bitrate that is based on the relative sizes of the encoded frames FRN-FRN+3. Also, since two frames corresponding to channel CH1 are transmitted between time A and time B (e.g., FRN and FRN+3), the transmission of the encoded frame FRN is completely transmitted before the encoded frame FRN+3 begins being transmitted. The bitrate associated with each channel CH1 412, CH2, 414, and CH3 416 remains constant between time A and time B, rather than fluctuating between the target bitrate and zero, as in the unsmoothed example.

Between time B and time C, each channel CH1-3 has a respective bitrate that is different than the respective bitrates between time A and time B due to differences in relative sizes of the encoded frames FRN+4-FRN+7, but the fluctuations between time intervals is less than the fluctuations between the target bitrate and zero, as in the unsmoothed case. Additionally, since two frames corresponding to channel CH2 are transmitted between time A and time B (e.g., FRN+4 and FRN+7), the transmission of the encoded frame FRN+4 is completely transmitted before the encoded frame FRN+7 begins being transmitted. Thus, while the bitrates of the channels CH1-3 vary from time interval to time interval (e.g., time interval AB to time interval BC), the magnitude of the changes of the bitrates may be reduced as compared to the unsmoothed example.

It will be appreciated that, while the exemplary timing diagrams 400 and 401 depict selecting four encoded frames to be transmitted together between time A and time B and between time B and time C, the selected group of encoded frames may be more or less than four encoded frames. Further the relative frame sizes may be any combinations of sizes. Further, while the timing diagram 401 depicts respective bitrates associated with channels CH1-3, the respective bitrates may vary from the respective bitrates depicted based on relative sizes of encoded frames associated with each channel CH1-3. It will also be appreciated that, while exemplary timing diagrams depicts selecting encoded frames from three channels, encoded frames from any number of channels CH0-CHN may be selected. Further, the target bitrate may be any bitrate, such as a constant bitrate of an associated communication link.

Components described herein, including but not limited to the statmux systems, rate controllers, and encoders described herein, may be implemented in all or in part using software in some examples. The software may be implemented using instructions encoded on one or more computer readable media. Any electronic storage (e.g. memory) may be used to implement the computer readable media, which may be transitory or non-transitory. The computer readable media may be encoded with instructions for performing the acts described herein, including but not limited to, rate control, encoding, QP selection, buffering, and combinations thereof. The instructions may be executable by one or more processing units to perform the acts described. The processing units may be implemented using any number and type of hardware capable of executing the instructions including, but not limited to, one or more processors, circuitry, or combinations thereof

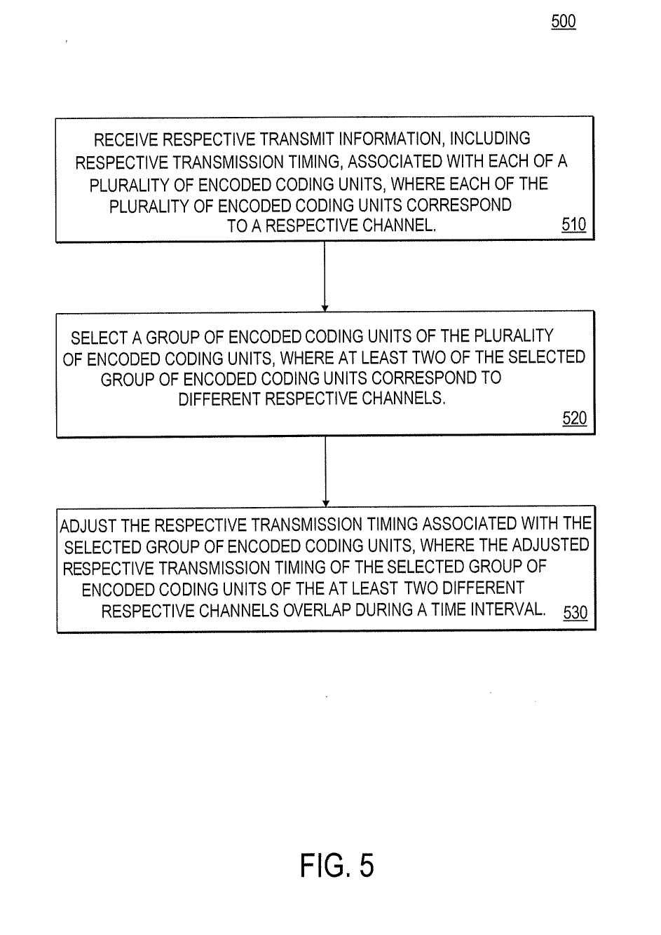

FIG. 5 is a flowchart 500 for a method for smoothing a bitrate of individual channels according to an embodiment of the disclosure. The method illustrated by the flowchart 500 may be implemented by the statmux with bitrate smoother 110 of FIG. 1, the statmux with the bitrate smoother 210 of FIG. 2, and/or the statmux with the bitrate smoother 310 of FIG. 3.

The method 500 may include receiving respective transmit information associated with each of a plurality of encoded coding units, at 510. Each of the plurality of encoded coding units may correspond to a respective channel. The respective transmit information may include respective transmission timing. The respective transmit information may be received at the statmux with the bitrate smoother 110 of FIG. 1, the rate controller with the bitrate smoother 230 of FIG. 2, and/or the bitrate smoother 334 of FIG. 3. In an embodiment, the transmit information may be provided by a rate controller, such as the rate controller 336 of FIG. 3.

The method 500 may further include selecting a group of encoded coding units of the plurality of encoded coding units, where at least two of the selected group of encoded coding units correspond to different respective channels, at 520. The method 500 may further include adjusting the respective transmission timing associated with the selected group of encoded coding units, at 530. The adjusted respective transmission timing of the selected group of encoded coding units may overlap during a time interval. Adjusting the respective transmission timing associated with the selected group of encoded coding units may include adjusting a respective transmit begin time associated with one or more of the selected group of encoded coding units. Adjusting the respective transmit begin time associated with one or more of the selected group of encoded coding units may include sequentially staggering the respective transmit begin times based on relative sizes of each of the selected group of encoded coding units, a packet size, and a target bitrate.

Adjusting the respective transmission timing associated with the selected group of encoded coding units may further include adjusting a respective transmit end time associated with one or more of the selected group of encoded coding units. Adjusting a respective transmit end time associated with one or more of the selected group of encoded coding units may include sequentially staggering the respective transmit end times based on the relative sizes of each of the selected group of encoded coding units, the packet size, and the target bitrate.

When a first selected encoded coding unit coding unit and a second selected encoded coding unit are from the same channel, the method 500 may further include the respective transmission time associated with the first selected encoded coding unit and the second selected encoded coding unit such that a transmit begin time of the second encoded coding unit is after a transmit end time of the first encoded coding unit. For example, the transmit end time of the first selected encoded, coding unit and the transmit begin time of the second selected encoded coding unit are determined based on relative sizes the first selected encoded coding unit and the second selected encoded coding unit. The method 500 may further include providing the transmit information including the adjusted respective transmission timing to a multiplexer.

The method 500 may be implemented by a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, the method 500 may be implemented by a computing system using, for example, one or more processing units that may execute instructions for performing the method that may be encoded on a computer readable medium. The processing units may be implemented using, e.g. processors or other circuitry capable of processing (e.g. one or more controllers or other circuitry). The computer readable medium may be transitory or non-transitory and may be implemented, for example, using any suitable electronic memory, including but not limited to, system memory, flash memory, solid state drives, hard disk drives, etc. One or more processing units and computer readable mediums encoding executable instructions may be used to implement all or portions of encoders or encoding systems described herein.

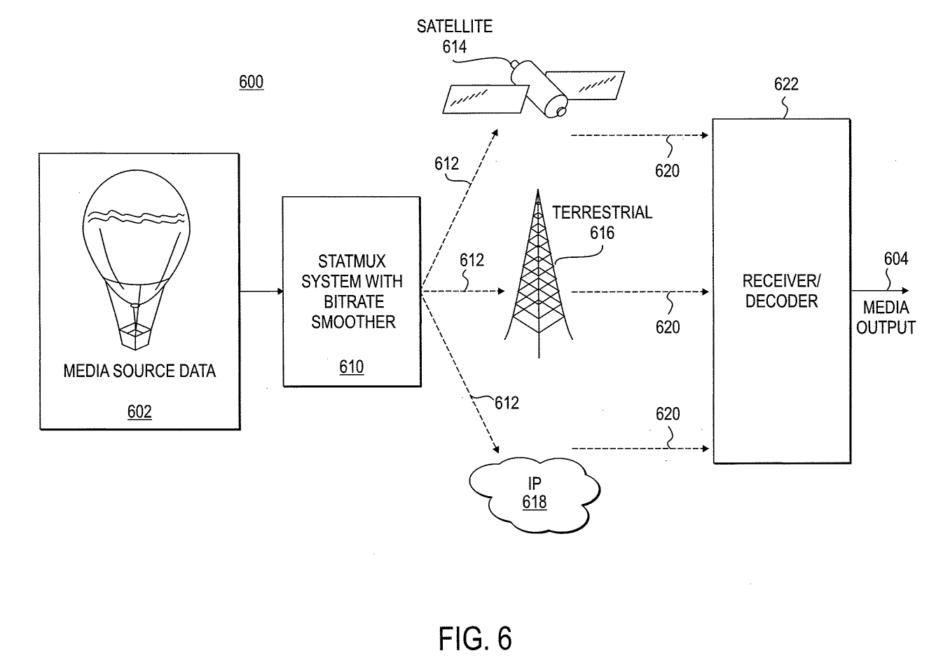

FIG. 6 is a schematic illustration of a media delivery system 600 in accordance with embodiments. The media delivery system 600 may provide a mechanism for delivering a media source 602 to one or more of a variety of media output(s) 604. Although only one media source 602 and media output 604 are illustrated in FIG. 6, it is to be understood that any number may be used, and examples may be used to broadcast and/or otherwise deliver media content to any number of media outputs.

The media source data 602 may be any source of media content, including but not limited to, video, audio, data, or combinations thereof. The media source data 602 may be, for example, audio and/or video data that may be captured using a camera, microphone, and/or other capturing devices, or may be generated or provided by a processing device. Media source data 602 may be analog or digital. When the media source data 602 is analog data, the media source data 602 may be converted to digital data using, for example, an analog-to-digital converter (ADC). The media source data 602 may represent several channels of media source data. Typically, to transmit each channel of the media source data 602, some type of compression and/or encryption may be desirable, with the compressed/encrypted channels being distributed over a common link. Accordingly, a statistical multiplexer with a bitrate smoother (RC) 610 may be provided that may encode each channel of the media source data 602 using any encoding method in the art, known now or in the future, including encoding methods in accordance with video standards such as, but not limited to, MPEG-2, MPEG-4, H.264, HEVC, or combinations of these or other encoding standards.

The statistical multiplexer with the bitrate smoother 610 may combine encoded data of each channel of the media source data 602 based on a bandwidth of a communication link and to provide the combined encoded data 612 over a communications link. Examples of communications links may include a satellite 614, an antenna 616, and/or a network 618. The statistical multiplexer with the bitrate smoother 610 may be implemented using any statistical multiplexer with bitrate smoother described herein, including the statistical multiplexer with the bitrate smoother 110 of FIG. 1, the statistical multiplexer with the bitrate smoother 210 of FIG. 2, and/or the statistical multiplexer with the bitrate smoother 310 of FIG. 3. The network 618 may be wired or wireless, and further may communicate using electrical and/or optical transmission. The antenna 616 may be a terrestrial antenna, and may, for example, receive and transmit conventional AM and FM signals, satellite signals, or other signals known in the art. The communications communication link may broadcast the combined encoded data 612, and in some examples may alter the combined encoded data 612 and broadcast the altered combined encoded data 612 (e.g., by re-encoding, adding to, or subtracting from the combined encoded data 602). The combined encoded data 620 provided from the communications communication link may be received by a receiver 622 that may include or be coupled to a decoder. The decoder may decode the combined encoded data 620 to provide one or more media outputs, with the media output 604 shown in FIG. 6.

The receiver 622 may be included in or in communication with any number of devices, including but not limited to a modem, router, server, set-top box, laptop, desktop, computer, tablet, mobile phone, etc.

The media delivery system 600 of FIG. 6 and/or the statistical multiplexer with the bitrate smoother 610 may be utilized in a variety of segments, of a content distribution industry.

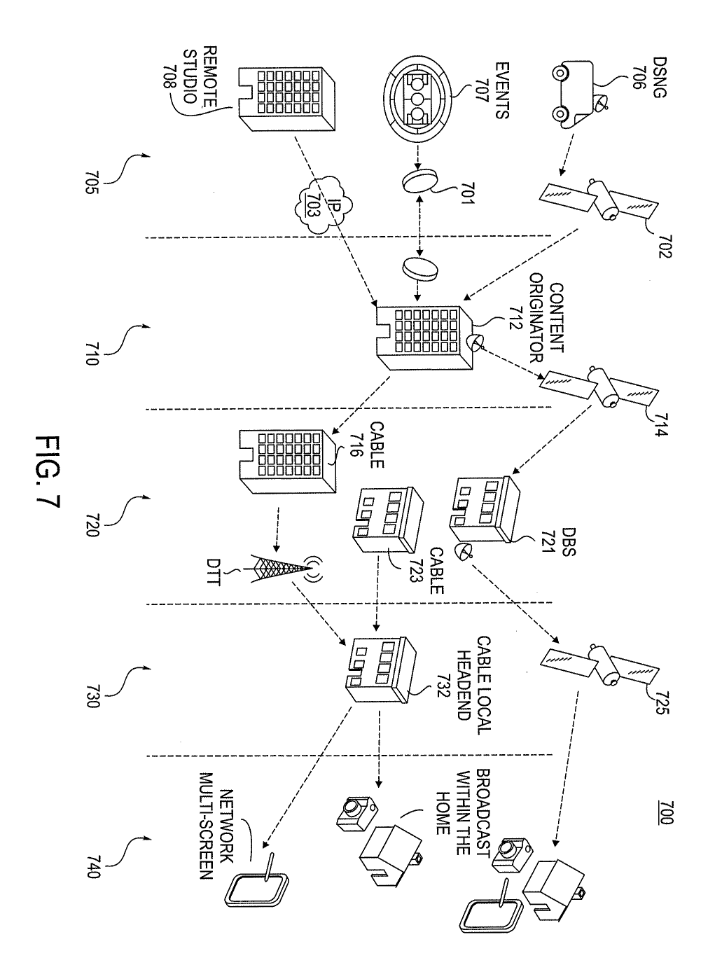

FIG. 7 is a schematic illustration of a video distribution system that 700 may make use of encoders described herein. The video distribution system 700 includes video contributors 705. The video contributors 705 may include, but are not limited to, digital satellite news gathering systems 706, event broadcasts 707, and remote studios 708. Each or any of these video contributors 705 may utilize statistical multiplexers with a bitrate smoother described herein, such as the statistical multiplexer with the bitrate smoother 610 of FIG. 6, to encode and combine multiple channels of media source data and provide combined channel encoded data to a communications link. The digital satellite news gathering system 706 may provide combined channel encoded data to a satellite 702. The event broadcast 707 may provide combined channel encoded data to an antenna 701. The remote studio 708 may provide combined channel encoded data over a network 703.

A production segment 710 may include a content originator 712. The content originator 712 may receive combined channel encoded data from any or combinations of the video contributors 705. The content originator 712 may make the received content available, and may edit, combine, and/or manipulate any of the received content to make the content available. The content originator 712 may utilize statistical multiplexers with global RC described herein, such as the statistical multiplexer with the bitrate smoother 610 of FIG. 6, to provide combined channel encoded data to the satellite 714 (or another communications link). The content originator 712 may provide combined channel encoded data to a digital terrestrial television system 716 over a network or other communication link. In some examples, the content originator 712 may utilize a decoder to decode the content received from the contributor(s) 705. The content originator 712 may then re-encode and combine data; potentially utilizing statistical multiplexers with global RC described herein, such as the statistical multiplexer with the bitrate smoother 610 of FIG. 6, and provide the combined channel encoded data to the satellite 714. In other examples, the content originator 712 may not decode the received data, and may utilize a transcoder (which may include an encoder of the statistical multiplexer with the bitrate smoother 610 of FIG. 6) to change an encoding format of the received data.

A primary distribution segment 720 may include a digital broadcast system 721, the digital terrestrial television system 716, and/or a cable system 723. The digital broadcasting system 721 may include a receiver, such as the receiver 622 described with reference to FIG. 6, to receive combined channel encoded data from the satellite 714. The digital terrestrial television system 716 may include a receiver, such as the receiver 622 described with reference to FIG. 6, to receive combined channel encoded data from the content originator 712. The cable system 723 may host its own content which may or may not have been received from the production segment 710 and/or the contributor segment 705. For example, the cable system 723 may provide its own media source data 602 as that which was described with reference to FIG. 6.

The digital broadcast system 721 may include an encoder, such as the statistical multiplexer with the bitrate smoother 610 of FIG. 6, to provide encoded data to the satellite 725. The cable system 723 may include a statistical multiplexer with VBV shifter, such as the statistical multiplexer with the bitrate smoother 610 of FIG. 6 as described with reference to FIG. 6, to provide combined channel encoded data over a network or other communications communication link to a cable local headend 732. A secondary distribution segment 730 may include, for example, the satellite 725 and/or the cable local headend 732.

The cable local headend 732 may include a statistical multiplexer with bitrate smoother, such as the statistical multiplexer with the bitrate smoother 610 of FIG. 6, to provide combined channel encoded data to clients in a client segment 740 over a network or other communications link. The satellite 725 may broadcast signals to clients in the client segment 740. The client segment 740 may include any number of devices that may include receivers, such as the receiver 622 and associated decoder described with reference to FIG. 6, for decoding content, and ultimately, making content available to users. The client segment 740 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
a statistical multiplexing (statmux) system for use with a communication link, the statmux system comprising:
a bitrate smoother; and
a plurality of encoders, wherein an encoder of the plurality of encoders is configured to provide a respective encoded bitstream of encoded coding units, the bitrate smoother configured to select a group of encoded coding units, wherein the selected group of encoded coding units includes encoded coding units of at least two different respective encoded bitstreams, the bitrate smoother further configured to adjust respective transmission timing of the selected group of encoded coding units, such that transmission timing of the selected group of encoded coding units of the at least two different respective encoded bitstreams overlap during a time interval.

2. The apparatus of claim 1, wherein the bitrate smoother configured to adjust the respective transmission timing of the respective transmit information associated with each of the selected group of encoded coding units comprises adjusting a respective transmit begin time associated with one or more of the selected group of encoded coding units and adjusting a respective transmit end time associated with one or more of the selected group of encoded coding units.

3. The apparatus of claim 2, wherein the bitrate smoother configured to adjust the respective transmit begin time and the respective transmit end time associated with one or more encoded bitstreams of the selected group of encoded coding units comprises:
starting with a start time of the transmit interval, sequentially staggering the respective transmit begin times associated with the one or more encoded bitstreams based on relative sizes of each of the selected group of encoded coding units, a packet size, and a target bitrate; and
sequentially staggering the respective transmit end times associated with the one or more encoded bitstreams based on the relative sizes of each of the selected group of encoded coding units, the packet size, and the target bitrate, wherein the respective transmit end time of a last encoded coding unit of the selected group of encoded coding units is equal to an end time of the transmit interval.

4. The apparatus of claim 1, further comprising a rate controller configured to provide the respective transmit information associated with each of the selected group of encoded coding units.

5. The apparatus of claim 4, wherein the rate controller is configured to receive respective statistical information from each of the plurality of encoders responsive to encoding a respective coding unit, wherein the rate controller is configured to generate the respective transmission timing associated with each of the selected group of encoded coding units based on the respective statistical information associated with each of the selected group of encoded coding units.

6. The apparatus of claim 1, further comprising a model output buffer, wherein a level of the model output buffer is updated in a first direction based on sizes of encoded coding units received from the plurality of encoders and is updated in a second direction based on a target bitrate.

7. The apparatus of claim 6, wherein the bitrate smoother configured to select the group of encoded coding units is further based on the respective level of the model output buffer associated with each of the selected group of encoded coding units.

8. The apparatus of claim 7, wherein the respective transmit information associated with each of the selected group of encoded coding units includes a respective encoded coding units size and a respective decode time stamp, where the bitrate smoother is further configured to, for an encoded coding unit of an respective encoded bitstream, determine a respective buffer delay based on the respective level of the model output buffer associated with the encoded coding unit and the target bitrate, wherein the bitrate smoother configured to select at the least two encoded coding units is further based on the DTS associated with each of the selected group of encoded coding units and the respective buffer delay associated with each of the selected group of encoded coding units.

9. The apparatus of claim 1, further comprising a multiplexer configured to receive a control signal from the bitrate smoother, the control signal including the respective transmit information including the adjusted transmission timing associated with each of the selected group of encoded coding units, the multiplexer configured to packetize an encoded coding unit of the selected group of encoded coding units into at least two respective packets, the multiplexer configured to periodically transmit the at least two respective packets associated with the encoded coding unit based on the respective adjusted transmission timing.

10. The apparatus of claim 9, wherein the multiplexer is configured to interleave transmission of respective at least two packets associated with a first encoded coding unit of the selected group of encoded coding units with respective at least two packets associated with a second encoded coding unit of the selected group of encoded coding units.

11. A non-transitory computer-readable medium encoded with instructions comprising instructions that, when executed by one or more processing units, cause the one or more processing units to:
identify a first encoded coding unit of a first encoded bitstream based on first transmit information;
select a second encoded coding unit of a second encoded bitstream based on second transmit information and the first transmit information; and
adjust transmission timing of the first transmit information and transmission timing of the second transmit information over a time interval associated with the first transmit information and the second transmit information.

12. The non-transitory computer-readable medium of claim 11, wherein the instructions further comprise instructions that when executed by one or more processing units, cause the one or more processing units to:
determine a start time of the time interval based on the first transmit information; and
determine an end time of the time interval based on the second transmit information.

13. The non-transitory computer-readable medium of claim 11, wherein the instructions further comprise instructions that, when executed by the one or more processing units, cause the one or more processing units to:
determine a relative size difference between the first encoded coding unit and the second encoded coding unit; and
stagger a transmit begin time of the first transmit information and the transmit begin time of the second transmit information based on the relative size difference; and
stagger a transmit end time of the first transmit information and the transmit end time of the second transmit information based on the relative size difference.

14. The non-transitory computer-readable medium of claim 13, wherein the instructions that, when executed by the one or more processing units, cause the one or more processing units to stagger a transmit begin time of the first transmit information and the transmit begin time of the second transmit information based on the relative size difference comprises instructions that, when executed by the one or more processing units, cause the one or more processing units to:
if the first encoded coding unit and the second encoded coding unit are of equal size:
set the transmit begin time of the second transmit information to the transmit begin time of the first transmit information plus a time necessary to transmit a single packet at a target bitrate; and
set the transmit end time of the first transmit information to the transmit end time of the second transmit information minus a time necessary to transmit the single packet at the target bitrate; and
if the first encoded coding unit and the second encoded coding unit are of different sizes:
set the transmit begin time of the second transmit information to the transmit begin time of the first transmit information plus a time necessary to transmit a first count of one or more packets at a target bitrate, wherein the first count of one or more packets is determined based on the relative size difference; and
set the transmit end time of the first transmit information to the transmit end time of the second transmit information minus a time necessary to transmit a second count of one or more packets at the target bitrate, wherein the second count of one or more packets is determined based on the relative size difference.

15. The non-transitory computer-readable medium of claim 11, wherein the first encoded coding unit comprises a first encoded frame, and wherein the second encoded coding unit comprises a second encoded frame.

16. A method, comprising:
receiving respective transmit information associated with each of a plurality of encoded coding units, wherein each of the plurality of encoded coding units correspond to a respective channel, wherein the respective transmit information includes respective transmission timing;
selecting a group of encoded coding units of the plurality of encoded coding units, wherein at least two of the selected group of encoded coding units correspond to different respective channels; and
adjusting respective transmission timing associated with the selected group of encoded coding units, wherein the adjusted respective transmission timing of the selected group of encoded coding units of the at least two different respective channels overlap during a time interval.

17. The method of claim 16, further comprising providing the transmit information including the adjusted transmission timing to a multiplexer.

18. The method of claim 16, wherein adjusting the respective transmission timing associated with the selected group of encoded coding units comprises:
adjusting a respective transmit begin time associated with one or more of the selected group of encoded coding units; and
adjusting a respective transmit end time associated with one or more of the selected group of encoded coding units.

19. The method of claim 18, wherein adjusting a respective transmit begin time associated with one or more of the selected group of encoded coding units comprises sequentially staggering the respective transmit begin times based on relative sizes of each of the selected group of encoded coding units, a packet size, and a target bitrate, and wherein adjusting a respective transmit end time associated with one or more of the selected group of encoded coding units comprises sequentially staggering the respective transmit end times based on the relative sizes of each of the selected group of encoded coding units, the packet size, and the target bitrate.

20. The method of claim 16, further comprising, when a first encoded coding unit of the selected group of encoded coding units and a second encoded coding unit of the selected group of encoded coding units are from the same channel, adjusting the respective transmission time associated with the first encoded coding unit and the second encoded coding unit such that a transmit begin time of the second encoded coding unit is after a transmit end time of the first encoded coding unit.

21. The method of claim 20, wherein the transmit end time of the first encoded coding unit and the transmit begin time of the second encoded coding unit are determined based on relative size differences between the first encoded coding unit and the second encoded coding unit.
